(19) United States
(12) Patent Application Publication
(10) Pub. No.: US 2007/0147072 A1
(43) Pub. Date: Jun. 28, 2007

(54) Optical structures that provide directionally enhanced luminance

(75) Inventors: James J. Scobbo, Evansville, IN (US); Cherian Jacob, Brecksville, OH (US); Robert L. Tatterson, Evansville, IN (US); Keshav S. Gautam, Evansville, IN (US)

Correspondence Address: FOLEY AND LARDNER LLP;SUITE 500, 3000 K STREET NW, WASHINGTON, DC, 20007, US

(73) Assignee: GENERAL ELECTRIC COMPANY

(21) Appl. No.: 11/315,214

(22) Filed: Dec. 23, 2005

(51) Int. Cl. F21V 7/04

(52) U.S. Cl. 362/607; 362/627; 362/612

(57) ABSTRACT

An optical structure is described. The optical structure includes a light source emitting light in a first wavelength range. The optical structure also includes a light redirecting element arranged to receive light from the light source and provide redirected light redirected in a preferred direction or orientation. The light redirecting element comprises a material which absorbs light in a second wavelength range within the first wavelength range such that the redirected light is in a third wavelength range.

### FIELD OF THE INVENTION

The invention relates to optical structures including elements for redirecting light, and displays incorporating such structures.

### BACKGROUND OF THE INVENTION

A number of optical systems include optical elements that act to redirect light in a preferred direction or orientation. For example it is well known in optical systems to include lenses or focusing mirrors that act to focus, collimate or otherwise redirect light. As another example of an optical element that redirects light in a preferred direction or orientation, light management films are used in retroreflective signs, and are used as brightness enhancement films (BEFs).

BEFs are often employed as components of liquid crystal display (LCD) backlight modules. A typical function of a BEF in these LCD applications is to direct or turn light from an illumination source toward a viewer and through the LCD cell, thus making the display appear brighter and/or economizing on power consumption. Typically BEFs are formed of materials with a relatively high refractive index. A higher refractive index allows the BEF a greater ability to redirect light, and therefore improves the effectiveness of the BEF.

### SUMMARY OF THE INVENTION

According to one embodiment of the invention there is provided an optical structure. The optical structure comprises a light source emitting light in a first wavelength range; and a light redirecting element arranged to receive light from the light source and provide redirected light redirected in a preferred direction or orientation, wherein the light redirecting element comprises a material which absorbs light in a second wavelength range within the first wavelength range such that the redirected light is in a third wavelength range.

According to another embodiment of the invention there is provided an optical display. The optical display comprises a light source emitting light in a first wavelength range; and a light redirecting element comprising at least one brightness enhancement film arranged to receive light from the light source and provide redirected light redirected in a preferred direction or orientation, wherein the light redirecting element comprises a material which absorbs light in a second wavelength range within the first wavelength range such that the redirected light is in a third wavelength range, wherein the at least one brightness enhancement film comprises one of a polymer material.

### BRIEF DESCRIPTION OF THE DRAWINGS

FIG. 1 is a schematic illustration of an optical structure according to an embodiment of the invention.

FIG. 2 is the transmission spectra of a polymer material comprising resorcinol arylate polyester chain members before and after exposure to ultra violet (UV) light.

FIG. 3 is a perspective view of an optical structure according to an embodiment of the invention.

FIG. 4 is a perspective view of an optical structure including an optical stack according to an embodiment of the invention.

FIG. 5 is a perspective view of two optical substrates with prismatic surfaces with the direction of the prismatic features oriented at an angle with respect to each other.

FIGS. 6A and 6B are a perspective view and cross sectional view, respectively, of an optical substrate with prismatic surfaces.

### DETAILED DESCRIPTION OF THE INVENTION

Features of the invention will become apparent from the drawings and the following detailed discussion, which by way of example without limitation describe preferred embodiments of the invention.

The present inventors have realized that a polymer material comprising resorcinol arylate polyester chain members is best suited for use as a material for a light redirecting element which redirects light in a preferred direction or orientation, for example in retroreflective signs applications and in applications employing directional luminance enhancement. A polymer material comprising resorcinol arylate polyester chain members has a relatively high refractive index of 1.62 (as compared to 1.586 for polycarbonate used in many light redirecting element applications). Examples of a polymer material comprising resorcinol arylate polyester chain members can be found, for example, in U.S. Pat. Nos. 6,306,507, 6,559,270 and 6,572,956, and in U.S. application entitled “LIGHT MANAGEMENT FILMS AND ARTICLES THEREOF”, G.E. docket no. 125677-2 based on U.S. Provisional Application 60/380,246 filed on May 10, 2002, for example, which are hereby incorporated by reference in their entirety.

For example, the polymer material comprising resorcinol arylate polyester chain members may comprise a thermoplastic polyester comprising structural units derived from a 1,3-dihydroxybenzene organodicarboxylate. Suitable polymers for this purpose, specifically arylate polymers, are disclosed in commonly owned application Ser. No. 09/152,877, now U.S. Pat. No. 6,143,839, the disclosure of which is incorporated by reference herein. Arylate polymers having a glass transition temperature of at least about 80° C. and no crystalline melting temperature, i.e., those that are amorphous, are preferred.

The arylate polymer is typically a 1,3-dihydroxybenzene isophthalate/terephthalate comprising structural units of the formula II: 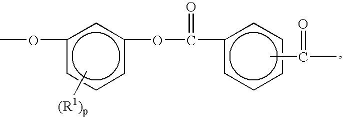
wherein each R¹ is a substituent, especially halo or C1-12 alkyl, and p is 0-3, optionally in combination with structural units of the following formula III: 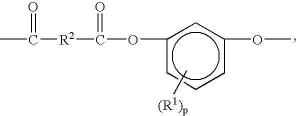
wherein R¹ and p are as previously defined and R² is a divalent C₄₋₁₂ aliphatic, alicyclic or mixed aliphatic-alicyclic radical.

Other acid groups, such as those derived from aliphatic dicarboxylic acids such as succinic acid, adipic acid or cyclohexane-1,4-dicarboxylic acid, or from other aromatic dicarboxylic acids such as 1,8-naphthalenedicarboxylic acid, may be present in the layer comprising a polymer material comprising resorcinol arylate polyester chain members, preferably in amounts no greater than about 30 mole percent. It is also within the scope of the invention for other polymers which are miscible in at least some proportions with the arylate polymer to be present, as discussed below. Most often, however, the coating layer polymer consists of units of formula II, optionally in combination with units of formula III.

The units of formula II contain a resorcinol or substituted resorcinol moiety in which any R¹ groups are preferably C₁₋₄ alkyl; i.e., methyl, ethyl, propyl or butyl. They are preferably primary or secondary groups, with methyl being more preferred. The most preferred moieties are resorcinol moieties, in which p is zero, although moieties in which p is 1 are also excellent with respect to the invention. Said resorcinol moieties are most often bound to isophthalate and/or terephthalate moieties.

In the optional soft block units of formula III, resorcinol or substituted resorcinol moieties are again present in ester-forming combination with R² which is a divalent C₄₋₁₂ aliphatic, alicyclic or mixed aliphatic-alicyclic radical. It is preferably aliphatic and especially C₈₋₁₂ straight chain aliphatic.

It is usually found that the arylate polymers most easily prepared, especially by interfacial methods, consist of units of formula II and especially combinations of resorcinol isophthalate and terephthalate units in a molar ratio in the range of about 0.25-4.0:1, preferably about 0.4-2.5:1, more preferably about 0.67-1.5:1, and most preferably about 0.9-1.1:1. When that is the case, the presence of soft block units of formula IV is usually unnecessary. If the ratio of units of formula III is outside this range, and especially when they are exclusively iso- or terephthalate, the presence of soft block units may be preferred to facilitate interfacial preparation. A particularly preferred arylate polymer containing soft block units is one consisting of resorcinol isophthalate and resorcinol sebacate units in a molar ratio between 8.5:1.5 and 9.5:0.5.

The present inventors have also realized, however, that a polymer material comprising resorcinol arylate polyester chain members may not be appropriate for some applications without compensating for the color shift that occurs in a polymer material comprising resorcinol arylate polyester chain members upon being exposed to UV light. For example, in back light modules for LCD display applications it is often desired that the light output from a BEF of the module be predominately white light. A polymer material comprising resorcinol arylate polyester chain members, however, experiences a color shift when exposed to UV light and turns yellow. A yellow tinted film is not desired in many backlight module applications because of the yellow tint created in the display. Thus, for those applications where the light source emits essentially white light, such as for example, cold cathode fluorescent light (CCFL) illuminated applications, and where it is desired to have predominately white light output from the display, it is desirable that the yellow tint from a polymer material comprising resorcinol arylate polyester chain members be compensated for.

The present inventors have found a way to provide optical systems using the high index of refraction of a polymer material comprising resorcinol arylate polyester chain members without creating a yellow tint in the display. In this regard, in some embodiments a polymer material comprising resorcinol arylate polyester chain members is arranged in conjunction with a white light emitting light source, such as one comprising an LED, where the light source can be designed to emit bluish white light to compensate for the yellow shift in a polymer material comprising resorcinol arylate polyester chain members, thus resulting in output of predominately white light.

The present invention, however, is not limited to arranging a light redirecting element of a polymer material comprising resorcinol arylate polyester chain members and a light source such that the composite optical structure provides predominately white light. In general the spectrum of the light produced by the composite optical structure will depend upon the particular application. Also in general the light redirecting element may be formed of a material other than a polymer material comprising resorcinol arylate polyester chain members. In general the light redirecting element may be formed of a material where the material comprises homopolymer or blends of resin systems comprising resorcinol arylate polyester chain members, brominated polycarbonate, polyphthalatecarbonate, polycarbonates, polyestercarbonate, or polyesters such as PCCD, PCTG, PCT, PETG, PBT, PET, acrylic resins such as PMMA, and polyimides including polyetherimide, and polyacrylates.

Preferably, the polymer material for the light redirecting element is a high refractive index polymer which may include brominated polycarbonate, polyphthalatecarbonate, polycarbonates, polyestercarbonate, polyesters and polyetherimides.

Most the polymer material for the light redirecting element comprises resorcinol arylate polyester chain members, and may include Poly(1,4-cyclohexylenedimethylene 1-4 cyclohexanedicarboxylate) (PCCD), Poly(co-ethylene-1,4 cyclohexylenedimethylene-1-4 cyclohexanedicarboxylate) (PETG/PCTG), Poly(cyclohexylenedimethylene-1-4 cyclohexanedicarboxylate) (PCT), Polyethylene terepthalate (PET), and Polybutylene terephalate (PBT).

Further, miscible blends of polycarbonate, polyesters, polyester carbonates, and polyarylates with resorcinol based arylate polymers provide additional flexibility in tailoring the refractive index and thereby the light redirecting capability of the elements.

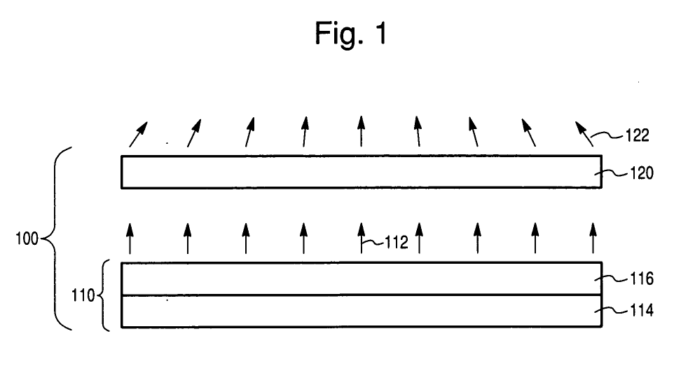

FIG. 1 is a schematic illustrating an optical structure 100 according to one embodiment of the invention. The optical structure 100 includes a light source 110 and a light redirecting element 120. The light source 110 emits light 112 within a first wavelength range Δλ₁. The light redirecting element 120 is arranged to receive the light 112 from the light source 110 and provide redirected light 122 redirected in a preferred direction or orientation. The light redirecting element 120 comprises a material, such as a polymer material comprising resorcinol arylate polyester chain members, which absorbs light in a second wavelength range Δλ₂ within the first wavelength range Δλ₁ such that the redirected light 122 is in a third wavelength range Δλ₃.

The optical structure 100 could be a television display or a computer display, or a component thereof, for example. The light redirecting element 120 could be a lens, lightguide, BEF, waveguide, or an optical fiber, for example.

The light source 110 may comprise a single light source, or alternatively, may comprise a primary light source 114 and a secondary light source 116. If the light source 110 comprises a primary light source 114 and a secondary light source 116, the primary light source 114 provides light in a fourth wavelength range Δλ₄ and the secondary light source 116 provides light in a fifth wavelength range Δλ₅.

If the light source 110 comprises a primary light source 114 and a secondary light source 116, the primary light source 114 may comprise at least one of a light emitting diode (LED), an organic light emitting diode (OLED), and a cold cathode fluorescent light (CCFL). Preferably the primary light source 114 is at least one of an LED and an OLED. The primary light source may be an LED emission chip, for example.

The secondary light source 116 may be an emission phosphor emitting light in the fifth wavelength range Δλ₅ upon absorbing light in the fourth wavelength range Δλ₄ from the primary light source 114. Examples of a primary light source-secondary light source system where the secondary light source is an emission phosphor are known, and are described, for example, in U.S. Pat. Nos. 6,409,938, 6,501,371 or U.S. Pat. No. 6,538,371, which are all hereby incorporated herein by reference. The combination of the light from the secondary light source 116 and the primary light source 114 provides light in the first wavelength range Δλ₁.

The second wavelength range Δλ₂ will depend upon the optical properties of the materials selected for the light redirecting element 120. For a given second wavelength range Δλ₂, the light in the first wavelength range Δλ₁ will be selected based upon the desired light spectrum or color of the light in the third wavelength range Δλ₃, i.e., the light spectrum or color of the redirected light 122. For a light source comprising a primary light source 114 and a secondary light source 116, once the first wavelength range Δλ₁ is known, the fourth wavelength range Δλ₄ and the fifth wavelength range Δλ₅ must conform to produce the first wavelength range Δλ₁.

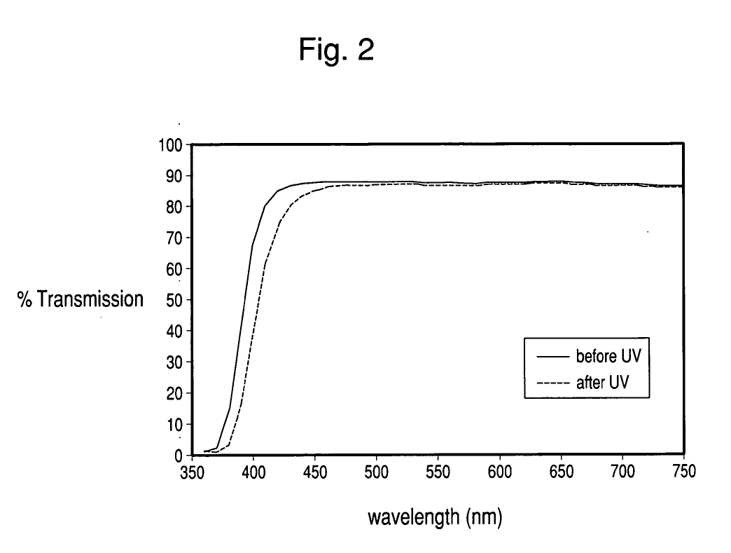

A polymer material comprising resorcinol arylate polyester chain members is a preferred material for the light redirecting element 120 in many applications because of its relatively high index of refraction of 1.62. A polymer material comprising resorcinol arylate polyester chain members is known to absorb light in the yellow region of the spectrum upon exposure to UV light. FIG. 2 shows the transmission spectra of a polymer material comprising resorcinol arylate polyester chain members before and after exposure to UV light, respectively. As can be seen, after exposure to UV light a polymer material comprising resorcinol arylate polyester chain members has a transmission such that the polymer material will appear yellow. In a similar fashion, brominated polycarbonate and polyphthalatecarbonate turn yellow upon sufficient exposure to UV light.

For a particular desired third wavelength range Δλ₃ of the redirected light 122, the yellow absorption of the polymer material comprising resorcinol arylate polyester chain members, which determines the second wavelength range Δλ₂, must be compensated for by choosing a particular first wavelength range Δλ₁. In other words, the light source 110 is selected so that it will produce a particular first wavelength range Δλ₁, which in turn depends on the yellow absorption of the polymer material, and the desired third wavelength range Δλ₃ of the redirected light 122.

As one example, of an optical system according to an embodiment of the invention, presume that the desired color of the third wavelength range Δλ₃ of the redirected light 122 is white, that a polymer material comprising resorcinol arylate polyester chain members with absorption in the yellow is the material of the light redirecting element 120, and the light source 110 comprises an LED as the primary light source and an emission phosphor as the secondary light source. Further, presume that the white light desired has 1931 CIE color coordinates of 0.31, 0.32. Color and chromaticity coordinates are explained in detail in several text books, such as pages 98-107 of K. H. Butler, “Fluorescent Lamp Phosphors” (The Pennsylvania State University Press 1980) and pages 109-110 of G. Blasse et al., “Luminescent Materials” (Springer-Verlag 1994), both incorporated herein by reference. In the absence of the yellow absorption of the polymer material comprising resorcinol arylate polyester chain members, the white light could be produced by a primary light source LED comprising an LED emission chip emitting in the blue, and as a secondary light source an emission phosphor emitting in the yellow. The primary light source-secondary light source combination can be “tuned” to compensate for the yellow absorption. For example, the phosphor's composition can be chosen to emit light in a wavelength range as desired.

The above example describes a system where it is desired to provide redirected light which has a white color with 1931 CIE color coordinates of 0.31, 0.32. Of course if the desired color of the redirected light 122 is different from white color with 1931 CIE color coordinates of 0.31, 0.32, the primary light source 114 and secondary light source 116 can be designed as required so that the desired color of the redirected light 122 is produced. For example, the primary light source 114 and secondary light source 116 can be designed to emit light that is relatively more blue or more yellow, as desired, so that the redirected light 122 is more blue or yellow.

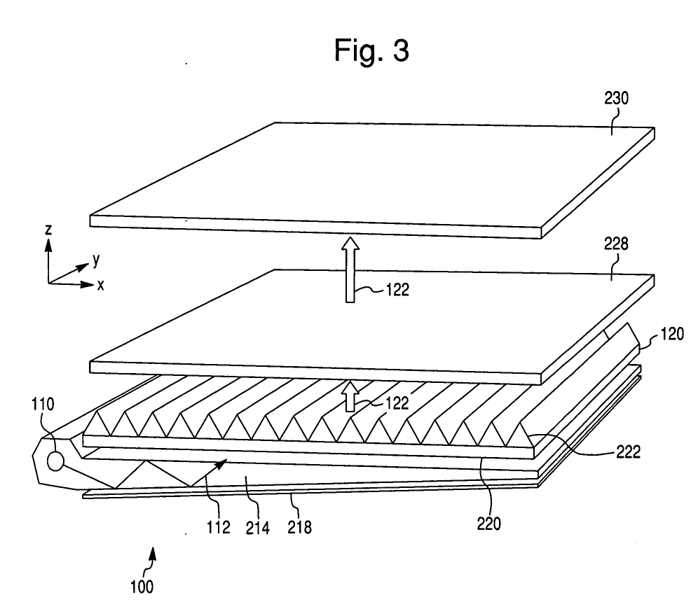

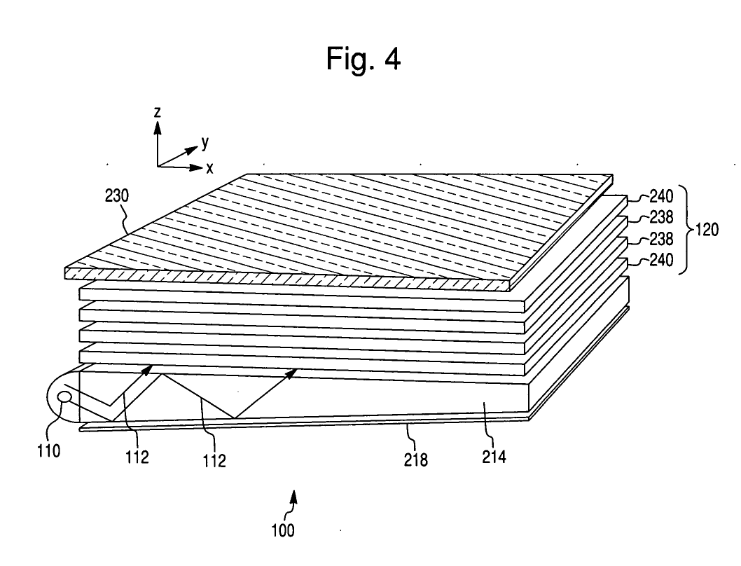

FIGS. 3 and 4 illustrate an embodiment where the optical structure 100 is an optical display, and more specifically is a backlight display. The optical structure 100 includes a light source 110 for generating light 112. The light source 110 may comprise a primary light source 114 and a secondary light source 116 as described above with respect to the embodiment of FIG. 1. A light guide 214 guides light 112 along its body from the light source 110. The light guide 214 contains disruptive features that permit the light 112 to escape the light guide 214. Such disruptive features may include a surface manufactured from a master having a machined cutting gradient. A reflective substrate 218 positioned along the lower surface of the light guide 214 reflects light 112 escaping from a lower surface of the light guide 214 back through the light guide 214 and toward the light redirecting element 120. The light directing element 120 may comprise a polymer material, such as that described above.

The light redirecting element 120 comprises at least one BEF in this embodiment. The light redirecting element 120 is receptive of the light 112 from the light guide 214. The light redirecting element 120 may comprise a planar surface 220 on one side and a three dimensional surface 222 comprising a number of prismatic features on the second opposing side. The light redirecting element 120 receives light 112 and redirects the light so as to provide redirected light 122 in a direction that is substantially normal to the light redirecting element 120 as shown. A diffuser 228 is located above the light redirecting element 120 to provide diffusion of the light 122. For example, the diffuser 228 can be a retarder film that rotates the plane of polarization of light exiting the light redirecting element 120 to match the light to the input polarization axis of an LCD display 230. The retarder film may be formed by stretching a textured or untextured polymer substrate along an axis in the plane of the light redirecting element 120. The light redirecting element 120 directs the redirected light 122 to the LCD display 230.

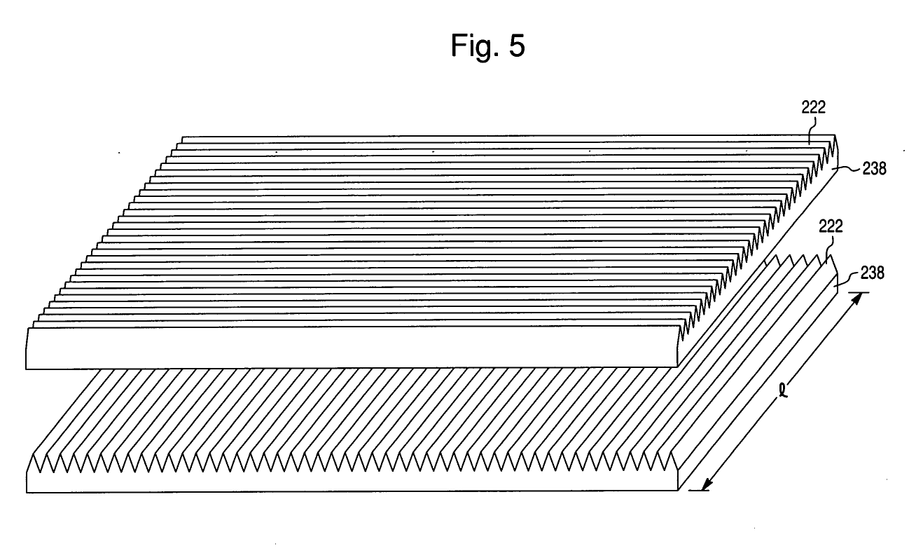

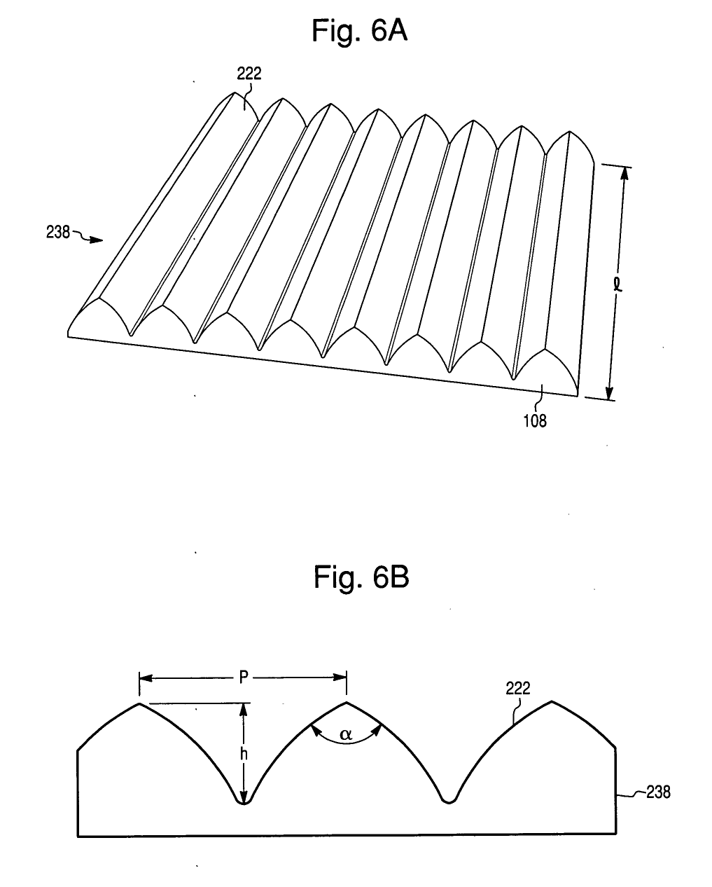

As illustrated in FIG. 4, the light redirecting element 120 of the optical structure 100 may comprise at least one BEF 238 and at least one diffuse film 240 arranged in a stack as shown. Furthermore, the prismatic structures of the surfaces 222 of the BEFs 238 may be oriented such that the direction of the structures are positioned at an angle with respect to one another, e.g., 90 degrees (see FIG. 5). Still further, it will be appreciated that the prismatic structures may have a peak angle, α, a height, h, a pitch, p, and a length, l (see FIGS. 6A and 6B). These parameters of peak angle, α, height, h, pitch, p, and length, l may have prescribed values or may have values which are randomized or at least psuedo-randomized. Films with prismatic surfaces with randomized or pseudo-randomized parameters are described, for example, in U.S. application Ser. No. 10/150,958 to Olcazk filed on May 20, 2002, which is hereby incorporated by reference herein.

Embodiments of the invention involve the combination of a high index of refraction film, such as one comprising a polymer material comprising resorcinol arylate polyester chain members, as a light management film in backlight modules comprised of LED sources that emit blue light. This approach solves a number of problems. It enables the use of high refractive index brightness enhancement films in an LED lighting format. While LEDs are known to be used for cell phone and PDA displays, LEDs could become more important in larger displays such as for computer and TV applications where CCFLs dominate today. Beyond a potential move away from CCFL technology, embodiments of the invention described above also satisfy a need for higher refractive index brightness enhancement films, and therefore more effective management of light, in small portable displays where battery life is important.

While the invention has been described with reference to several embodiments thereof, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An optical structure, comprising:
a light source emitting light in a first wavelength range; and
a light redirecting element arranged to receive light from the light source and provide redirected light redirected in a preferred direction or orientation, wherein the light redirecting element comprises a material which absorbs light in a second wavelength range within the first wavelength range such that the redirected light is in a third wavelength range.

2. The optical structure of claim 1, wherein the redirected light is substantially white.

3. The optical structure of claim 1, wherein the light source comprises a primary light source, the primary light source being at least one of a light emitting diode (LED), an organic light emitting diode (OLED), and a cold cathode fluorescent light (CCFL), the primary light source providing light in a fourth wavelength range.

4. The optical structure of claim 3, wherein the primary light source is at least one of a light emitting diode (LED) and an organic light emitting diode (OLED).

5. The optical structure of claim 3, wherein the primary light source comprises an emission chip.

6. The optical structure of claim 3, wherein the light source further comprises a secondary light source comprising an emission phosphor emitting light in a fifth wavelength range upon absorbing light from the primary light source.

7. The optical structure of claim 6, wherein the light in the fourth wavelength range comprises blue light, and the light in the fifth wavelength range comprises yellow light.

8. The optical structure of claim 1, wherein the light redirecting element comprises a polymer material comprising resorcinol arylate polyester chain members.

9. The optical structure of claim 1, wherein the light redirecting element comprises one of brominated polycarbonate or polyphthalatecarbonate.

10 The optical structure of claim 1, wherein the light redirecting element comprises at least one polymer selected from the group consisting of resorcinol based polyarylates, polycarbonates, polyester carbonates, polyesters, brominated polycarbonates, polyphthalatecarbonates, and polyimides.

11. The optical structure of claim 8, wherein the light redirecting element comprises a lightguide.

12. The optical structure of claim 1, wherein the light redirecting element comprises at least one of a lens, lightguide, brightness enhancement film, waveguide, and an optical fiber.

13. The optical structure of claim 1, wherein the optical structure is one of a television display and a computer display.

14. The optical structure of claim 1, wherein the light redirecting element comprises an optical stack, the optical stack comprising at least one brightness enhancing film, and at least one diffuse film.

15. The optical structure of claim 1, wherein the at least one brightness enhancing film comprises a polymer material comprising resorcinol arylate polyester chain members.

16. An optical display comprising:
a light source emitting light in a first wavelength range; and
a light redirecting element comprising at least one brightness enhancement film arranged to receive light from the light source and provide redirected light redirected in a preferred direction or orientation, wherein the light redirecting element comprises a material which absorbs light in a second wavelength range within the first wavelength range such that the redirected light is in a third wavelength range, wherein the at least one brightness enhancement film comprises at least one polymer selected from the group consisting of resorcinol based polyarylates, polycarbonates, polyester carbonates, polyesters, brominated polycarbonates, polyphthalatecarbonates, and polyimides.

17. The optical display of claim 16, wherein the at least one brightness enhancement film comprises a polymer material comprising resorcinol arylate polyester chain members.

18. The optical display of claim 16, wherein the redirected light is substantially white.

19. The optical display of claim 16, wherein the light source comprises a primary light source, the primary light source being at least one of a light emitting diode (LED), an organic light emitting diode (OLED), and a cold cathode fluorescent light (CCFL), the primary light source providing light in a fourth wavelength range.

20. The optical display of claim 19, wherein the primary light source is at least one of a light emitting diode (LED) and an organic light emitting diode (OLED).

21. The optical display of claim 19, wherein the primary light source comprises an emission chip.

22. The optical display of claim 19, wherein the light source further comprises a secondary light source comprising an emission phosphor emitting light in a fifth wavelength range upon absorbing light from the primary light source.

23. The optical display of claim 22, wherein the light in the fourth wavelength range comprises blue light, and the light in the fifth wavelength range comprises yellow light.

24. The optical display of claim 16, wherein the optical display is one of a television display and a computer display.

25. The optical structure of claim 16, wherein the light redirecting element comprises an optical stack, the optical stack comprising the at least one brightness enhancing film, and at least one diffuse film.
